(19) United States
(12) Patent Application Publication
(10) Pub. No.: US 2025/0002663 A1
(43) Pub. Date: Jan. 2, 2025

(54) COMPOSITE MATERIAL FOR VEHICLE TIRES, AND METHOD FOR PRODUCING SAME

(71) Applicant: Continental Reifen Deutschland GmbH, Hannover (DE)

(72) Inventors: Cornelia Schmaunz-Hirsch, Wunstorf (DE); Wolfgang Naumann, Lichtenfels (DE); Michael Jahr, Dresden (DE); Thomas Kramer, Herford (DE); Rainer Kahner, Arnsberg (DE)

(73) Assignee: Continental Reifen Deutschland GmbH, Hannover (DE)

(21) Appl. No.: 18/688,457

(22) PCT Filed: Aug. 24, 2022
(86) PCT No.: PCT/EP2022/073577

§ 371 Date: Mar. 1, 2024

(30) Foreign Application Priority Data
Sep. 3, 2021 (EP) 21194745.2

(51) Int. Cl. C08J 3/26; B60C 1/00; B60C 9/00; C08J 3/24; C08J 5/04; C08K 3/36; C08K 9/06; C09J 5/10

(52) U.S. Cl. CPC C08J 3/26; B60C 1/0025; B60C 9/0042; C08J 3/247; C08J 5/046; C08J 5/047; C08K 3/36; C08K 9/06; C09J 5/10; B60C 9/005; B60C 2200/12; C08J 2307/02; C08J 2333/06; C08J 2391/08; C08K 2201/006; C08K 2201/019

(57) ABSTRACT

The invention relates to a process for producing a vulcanizable composite material, comprising the steps of: a) producing or providing a textile strength member, b) treating the textile strength member with an aqueous dispersion for adhesive activation of the textile strength member and to obtain an adhesion-activated textile strength member and c) introducing the adhesion-activated textile strength member into a crosslinkable rubberization mixture to obtain the vulcanizable composite material, wherein the aqueous dispersion is essentially free of free resorcinol and resorcinol precondensates, especially resorcinol-formaldehyde precondensates, and is free of free formaldehyde and formaldehyde-releasing substances, wherein the crosslinkable rubberization mixture is processible by vulcanization to give a crosslinked rubberization mixture which is at least partly transmissive to visible light at least in sections.

### CROSS-REFERENCE TO RELATED APPLICATIONS

The present application is a National Stage Application under 35 U.S.C. § 371 of International Patent Application No. PCT/EP2022/073577 filed on Aug. 24, 2022, and claims priority from European Patent Application No. 21194745.2 filed on Sep. 3, 2021, the disclosures of which are herein incorporated by reference in their entireties.

### TECHNICAL FIELD

The invention relates to a process for producing a vulcanizable composite material and to a process based thereon for producing a vulcanized composite material or an elastomeric product, and to a corresponding vulcanizable composite material and to a vulcanized composite material producible therefrom or a corresponding elastomeric product. The invention further relates to a use of a specific aqueous dispersion for adhesive activation of textile strength members for composite materials comprising transparent rubberization mixtures.

### BACKGROUND

It is known that vehicle tires, for example bicycle tires, have textile strength members for reinforcement in various components. In many cases, other industrial rubber articles too, such as belts (including transmission belts) and hoses, have strength members. The strength members here are typically surrounded by at least one rubber mixture which is also referred to as rubberization mixture or, in the vulcanized state, as rubberization.

It is regularly a problem that the strength members and the surrounding rubberization generally have different mechanical properties, especially different strengths. Particularly in the case of sustained mechanical and dynamic stress, as occurs in traveling operation of the vehicle tire, there is therefore a need for sufficient adhesion between the strength members and the surrounding rubberization in order nevertheless to be able to assure adequate bond strength.

The prior art discloses activation of the strength members prior to rubberization for adequate adhesion (called activation of adhesion or adhesive activation), typically by using what are called RFL (resorcinol-formaldehyde latex) dips that can be applied by means of a dip bath, for example.

If permitted by the application-specific demands on the physicochemical properties of the rubberization, for example because the expected demands on a component are such that it is possible, for example, to dispense with the use of carbon black in the rubberization mixture, this rubberization can in principle be made transmissive to light, especially transparent.

As well as the benefits for the design-related configuration of such elastomeric products, especially elevated flexibility for product designers in the design of colorfully appealing designs with interesting depth effects, there has also been increasing focus for some time on the technical benefits enabled by a corresponding transparent configuration for the monitoring of the production process and quality control of the respective products.

While many customers in the case of bicycle tires, for example, find it visually appealing to be able to see the textile strength members in the bicycle tire through a transparent rubberization, the primary factor for the person skilled in the art is that they are able to subject the textile strength members in this configuration to a visual check.

In the systems known from the prior art, which make use of (optionally colored) RFL dips as adhesion promoter, however, the options in this regard are reduced in many cases. A particular reason for this is the regularly intense, red-brownish intrinsic color possessed by the RFL adhesion promoters known from the prior art, which is in many cases perceived as being disadvantageous.

Apart from the red-brownish intrinsic color which is frequently considered not to be very visually appealing, which also limits the colors achievable by means of colorant additions, this activation of adhesion regularly masks the color of the textile strength members, even though this could be very informative to the skilled person, especially for identification of the materials used on the basis of their color or for recognition of any manufacturer-specific markings, for example indicator filaments. Moreover, the interfacial region created between RFL-activated textile strength members and transparent rubberization mixtures is in many cases perceived to be disadvantageous since it makes it difficult to exactly identify individual strength members in many cases, especially when these can be discerned only with difficulty in any case from a dark rubber material beneath because of the red-brownish color.

### SUMMARY

The primary object of the present invention was that of eliminating or at least reducing the above-described disadvantages of the prior art.

It was thus an object of the present invention to specify a process for producing vulcanizable composite materials that can be used, by means of vulcanization, to obtain high-performance vulcanized composite materials having excellent optical properties that can be used in vehicle tires and other elastomeric products.

It was an object of the present invention for the vulcanized composite materials to enable maximum ease of identification and quality testing, in a reliable and in particular nondestructive manner, of the textile strength members present in the vulcanized composite materials, where it should especially also be possible to clearly distinguish between adjacent textile strength members, such that, for example, it is even possible to assess splice quality.

It was a supplementary object of the present invention for the vulcanized composite materials to have elevated flexibility over the prior art with respect to color configuration. It was especially desirable here for the base color of the textile strength members, in spite of any adhesion-activating coatings, to remain visible from the outside, especially in order to enable material identification by color and to make indicator filaments incorporated by the manufacturer visible from the outside.

It was an additional object of the present invention for the vulcanized composite materials to show sufficiently high bond strength between the textile strength members and the rubberization, and it was also desirable in the light of the above objects for the adhesion-promoting coating of the textile strength members to have high chemical compatibility with the rubberization, such that there is minimum light scatter at the interface.

It was a further object of the present invention for the positive color properties, by contrast with the case of RFL dips, for example, to be reproducible largely irrespective of the conditions used in the vulcanization.

It will be clear to the person skilled in the art that it was a supplementary object of the present invention additionally to specify a process for producing an elastomeric product, especially a vehicle tire, and a corresponding elastomeric product, especially a vehicle tire. It was a supplementary object of the present invention for the corresponding vehicle tires to make a contribution to safety of travel.

In addition, it was a supplementary object of the present invention to specify a specific use of an aqueous dispersion for activation of adhesion of textile strength members for composite materials with transparent rubberization mixtures for improvement of visual identifiability of the textile strength members in the transparent rubberization mixture, or for reduction of optical defects in the contact region between the textile strength members and the transparent rubberization mixture.

The aforementioned objects are achieved by means of the subject matter of the invention as defined in the claims. Preferred configurations according to the invention will be apparent from the subsidiary claims and from the details that follow.

### DETAILED DESCRIPTION

Embodiments that are referred to below as being preferred are, in particularly preferred embodiments, combined with features of other embodiments that are referred to as being preferred. Combinations of two or more of the embodiments that are described below as being particularly preferred are therefore very particularly preferred. Likewise preferred are embodiments in which a feature of one embodiment that is referred to as being preferred to a certain degree is combined with one or more further features of other embodiments that are referred to as being preferred to a certain degree. Features of preferred vulcanizable composite materials, vulcanized composite materials, elastomeric products and uses will be apparent from the features of preferred processes.

The invention relates to a process for producing a vulcanizable composite material, comprising the steps of:
a) producing or providing a textile strength member,
b) treating the textile strength member with an aqueous dispersion for adhesive activation of the textile strength member and to obtain an adhesion-activated textile strength member and
c) introducing the adhesion-activated textile strength member into a crosslinkable rubberization mixture to obtain the vulcanizable composite material, wherein the aqueous dispersion is essentially free of free resorcinol and resorcinol precondensates, especially resorcinol-formaldehyde precondensates, and is free of free formaldehyde and formaldehyde-releasing substances,
wherein the crosslinkable rubberization mixture is processible by vulcanization to give a crosslinked rubberization mixture which is at least partly transmissive to visible light at least in sections.

The process of the invention advantageously affords vulcanizable composite materials from which it is possible to obtain, by means of vulcanization, high-performance vulcanized composite materials having excellent bond strength and excellent optical properties for use in vehicle tires and other elastomeric products.

In the vulcanized composite materials obtained by the process of the invention, it is advantageously possible by virtue of the specifically chosen activation of adhesion and the optimized interfacial properties achievable thereby to clearly identify even comparatively deep-lying textile strength members from the outside in the vulcanized composite material, such that reliable and nondestructive quality testing is possible, for example even for the customer when buying a tire.

Even in the manufacture of the elastomeric products, quality control is more easily possible in this way, especially since the identifiability of individual strength members is so high that it is also possible to determine, for example, when an undesirably high or undesirably low density of strength members, especially in the splice region, is created in the splicing of the composite material.

In a synergistic manner, the chosen activation of adhesion surprisingly does not cause unwanted coloring, since this may advantageously be made colorless or transparent. This makes it possible to see the original color of the textile strength members, which advantageously means that information about the materials used in the textile strength members and/or manufacturer information, coded by indicator filaments for example, remains visible.

The process of the invention additionally makes it possible to significantly increase flexibility with regard to color configuration, since it is advantageously possible not just to color the rubberization (transparently colored) but likewise to color the textile strength members, such as a color of the adhesion-activating coating. It can considered here to be an advantage of the invention that the positive color properties are obtained largely irrespective of the temperatures used in the vulcanization.

Finally, it can be regarded as an advantage of the process of the invention that, in the vulcanized composite materials, depending on the mode of activation of adhesion, a slight gloss arises in the textile strength members, which, depending on the color chosen, can go in the direction of a metallic gloss. By virtue of the use of a corresponding composite material in place of a conventional, largely absorbent rubber material, this gloss increases the visibility of the tire specifically under difficult viewing conditions, since, for example, a higher proportion of incident headlamp light can be reflected.

The definition of the crosslinkable rubberization mixture via the properties of the rubberization producible therefrom by vulcanization, i.e. of the crosslinked rubberization mixture, is in accordance with the customary procedure in the art and the understanding of the person skilled in the art, since a corresponding definition in the case of corresponding polymeric materials having a structure that cannot be described exactly is regularly the only practicable way of defining the corresponding material. A vulcanized composite material producible from the vulcanizable composite material accordingly comprises a crosslinked rubberization mixture which is at least partly transmissive to visible light at least in sections.

In the context of the present invention, the expression “at least partly transmissive to visible light”, in accordance with the understanding of the person skilled in the art, means that the crosslinked rubberization mixture shows sufficiently little interaction with electromagnetic radiation of any wavelength in the visible region, or a portion of the wavelengths in the visible region, that the textile strength members in the vulcanizable composite material and in the vulcanized composite material are visible from the outside. This means that it is unnecessary for the crosslinked rubberization mixture to show no absorption at all in the visible wavelength region, since partial absorption, for example at particular wavelengths, can also be tolerated, especially in the case of transparently colored rubberizations.

According to the above definition, the crosslinked rubberization mixture is at least partly transmissive to visible light at least in sections. This means that the vulcanizable composite material or the vulcanized composite material may also include sections in which the rubberization has not been made transmissive, for example in the form of alternating regions or an opaque base beneath the textile strength members that are covered by a transmissive top layer.

The expression “essentially free of”, in accordance with the understanding of the person skilled in the art, in the context of the present invention, should be understood to mean that the corresponding substances may be present only in amounts that do not significantly influence the essential properties of the composition claimed. For example, the amount of these substances must not go beyond trace amounts that result from a contamination. Typically, in the aqueous dispersion for use in accordance with the invention, there should be not more than 0.1% by weight (dry weight), based on the total weight of aqueous dispersion, of each of the components specified, for instance resorcinol, resorcinol precondensates, formaldehyde and formaldehyde-releasing substances, i.e. 0.1% by weight is the maximum amount for each of the above components. The content of all these components in the aqueous dispersion is preferably 0% by weight.

The unit “phr” (parts per hundred parts of rubber by weight) used in the context of the present invention is the standard unit of quantity for mixture recipes in the rubber industry. The dosage of the parts by weight of the individual substances is always based here on 100 parts by weight of the total mass of all rubbers present in the mixture, which accordingly adds up to 100.

The process of the invention is advantageously suitable for all textile strength members known to the person skilled in the art. However, the inventors of the present invention were able to identify features of the textile strength member that are particularly suitable for the process of the invention.

To wit, a preferred process of the invention is one wherein the textile strength member is at least partly colored and/or comprises at least one indicator filament, preferably comprises at least one indicator filament. In this configuration, the advantages of the process of the invention are manifested particularly clearly. In the process of the invention, it is additionally also possible to provide air discharge filaments on one or more surfaces of the vulcanizable composite material, which, since they remain visible beneath the transmissive crosslinked rubberization mixture, can advantageously also be colored. Especially in the case of the later positioning of the vulcanized composite materials on the outside of vehicle tires, however, it is preferable not to provide any corresponding air discharge filaments at least on the outer surface.

Preference is additionally given to a process of the invention wherein the textile strength member comprises a material selected from the group consisting of polyesters, polyamides, polyurethanes, glass, carbon, celluloses, polycarbonates, polyketones and combinations of those materials, preferably selected from the group consisting of polyesters, regenerated cellulose, especially rayon, aramids, nylon and combinations of those materials, more preferably selected from the group consisting of nylon, where the textile strength member most preferably consists of those materials. Suitable polyesters include, for example, polyethylene terephthalate (PET), polyethylene naphthalate (PEN), polybutylene terephthalate (PBT), polyethylene furanoate (PEF) and polyester acrylates, which are supplied, for example, by Celanese AG under the Vectran trade name. Examples of polyamides are nylon-4,6 (PA 4.6), nylon-4,10 (PA 4.10), nylon-6 (PA 6), nylon-6,6 (PA 6.6 polyhexamethyleneadipamide), nylon-6,12 (PA 6.12), nylon-10,10 (PA 10.10) and nylon-12,12 (PA 12.12). Suitable polyamides are, for example, aromatic polyamides such as aramids, especially m-aramid, p-aramid, and mixtures of m-aramid and p-aramid. Suitable celluloses are, for example, regenerated celluloses (especially viscose or rayon) and cellulose esters.

Preference is also given to a process of the invention wherein the textile strength member comprises one or more reinforcement cords, preferably in the form of a weave, in each case comprising at least one yarn. For example, the textile reinforcement material may take the form of single- or multifilament textile cords or take the form of two-dimensional filament fabrics such as fillets based on single- or multifilament yarns.

Against this background, preference is given to a process of the invention wherein the textile strength member comprises one or more reinforcement cords, preferably in the form of a weave, in each case comprising at least two different yarns, where the yarns each preferably consist of a material selected from the group consisting of polyesters, polyamides, polyurethanes, glass, carbon, celluloses, polycarbonates and polyketones.

Preference is fundamentally given to a process of the invention wherein at least one of the yarns, preferably all the yarns, in the reinforcement cords have a linear density in the range from 90 to 5000 dtex, preferably in the range from 100 to 2500 dtex or in the range from 2500 to 4500 dtex, more preferably in the range from 200 to 1500 dtex or in the range from 3000 to 4000 dtex.

Preference is fundamentally also given to a process of the invention wherein at least one of the yarns, preferably all the yarns, in the reinforcement cords have a twist level of 100 to 600 T/m, preferably 150 to 550 T/m, more preferably 200 to 500 T/m.

Preference is fundamentally given additionally to a process of the invention wherein the polyamide yarn has a twist factor in the range from 100 to 400, preferably in the range from 150 to 350. The twist factor α is a parameter known to the person skilled in the art and is calculated from the twist level in T/m (turns per meter) and the linear density in tex:

$$α = T / m \sqrt{\frac{tex}{1000}}$$

Preference is fundamentally likewise given to a process of the invention wherein at least one of the reinforcement cords, preferably all the reinforcement cords, have two or more yarns, where the yarns in the reinforcement cord have preferably been end-twisted together at 100 to 600 T/m, more preferably at 150 to 550 T/m, most preferably at 200 to 500 T/m.

Preference is fundamentally also given to a process of the invention wherein at least one of the reinforcement cords, preferably all the reinforcement cords, have an overall linear density in the range from 180 to 10 000 dtex, preferably in the range from 200 to 7500 dtex, more preferably in the range from 400 to 5000 dtex.

It will be apparent to the person skilled in the art that it is also possible in the process of the invention to process multiple strength members and incorporate them into a corresponding vulcanizable composite material. For the predominant number of cases, a corresponding process design is actually preferred. Preference is accordingly given to a process of the invention wherein the process is conducted for two or more textile strength members.

The production of vulcanizable rubberization mixtures that result in transmissive, especially transparent, vulcanized rubberization mixtures after vulcanization is known in principle to the person skilled in the art from the prior art, for example from DE 8234954 U1, U.S. Pat. No. 6,624,220 B1 and US 2004/0044118 A1, and so the person skilled in the art can be guided by the prior art in the production.

As described above, it is possible to make merely parts of the rubberization transmissive, for example in that the crosslinkable rubberization mixture consists of two or more rubberization mixture components. Even though it may be preferred specifically in relation to the optical effect, easier manufacture means that preference is given in most cases to rubberizations that are essentially entirely transmissive. Preference is thus given to a process of the invention wherein the crosslinkable rubberization mixture comprises two or more separate rubberization mixture components, wherein at least one rubberization mixture component is processible by vulcanization to give a crosslinked rubberization mixture component which is at least partly transmissive to visible light. Preference is alternatively given to a process of the invention wherein the crosslinkable rubberization mixture is processible by vulcanization to give a crosslinked rubberization mixture which is at least partly transmissive to visible light essentially in its entirety.

With regard to the relevant wavelength ranges in which the rubberization should be transmissive, it is possible to define a suitable range, with particular preference for essentially no diffuse scattering by the rubberization, such that it is transparent. Preference is thus given to a process of the invention wherein the crosslinkable rubberization mixture is processible by vulcanization to give a crosslinked rubberization mixture which is at least partly transmissive to visible light having a wavelength in the range from 380 to 780 nm at least in sections, preferably essentially in its entirety. Preference is likewise given to a process of the invention wherein the crosslinkable rubberization mixture is processible by vulcanization to give a crosslinked rubberization mixture which is at least partly transparent to visible light at least in sections, preferably essentially in its entirety.

The inventors of the present invention have been able to identify compositions particularly suitable for the crosslinkable rubberization mixture.

To wit, preference is given to a process of the invention wherein the crosslinkable rubberization mixture comprises at least one diene rubber, where the diene rubber is preferably selected from the group consisting of halogenated copolymers of a C4 to C7 isoolefin and an alkylstyrene, natural polyisoprene (NR), synthetic polyisoprene (IR), butadiene rubber (BR), styrene-butadiene rubber (SBR), styrene-isoprene rubber, butyl rubber, nitrile rubber (NBR), chloroprene rubber, isoprene-butadiene rubber and ethylene-propylene rubber, where the diene rubber is more preferably selected from the group consisting of brominated copolymers of isobutylene and para-methylstyrene, natural polyisoprene, synthetic polyisoprene and cis-1,4-butadiene rubber. For example, the polyisoprene (IR, NR) may either be cis-1,4-polyisoprene or 3,4-polyisoprene. Preference is given, however, to using cis-1,4-polyisoprenes having a cis-1,4 content of >90% by weight. For example, it is possible to obtain such a polyisoprene by stereospecific polymerization in solution with Ziegler-Natta catalysts or using finely divided lithium alkyls. Moreover, natural rubber (NR) is such a cis-1,4-polyisoprene; the cis-1,4 content in natural rubber is greater than 99% by weight.

The polybutadiene (BR) may, for example, be cis-1,4-polybutadiene or vinylpolybutadiene (vinyl content about 10% to 90% by weight). Preference is given to using cis-1,4-polybutadiene with a cis-1,4 content greater than 90% by weight, which can be prepared, for example, by solution polymerization in the presence of catalysts of the rare earth type.

The styrene-butadiene copolymers (SBR) may, for example, be solution-polymerized styrene-butadiene copolymers (S-SBR) having a styrene content, based on the polymer, of about 10% to 45% by weight and a vinyl content (i.e. content of 1,2-bonded butadiene, based on the overall polymer) of 10% to 70% by weight, which can be prepared, for example, using lithium alkyls in organic solvents. The S-SBR may also be coupled and endgroup-modified. Alternatively, it is possible to use emulsion-polymerized styrene-butadiene copolymers (E-SBR) and mixtures of E-SBR and S-SBR. The styrene content of the E-SBR is about 15% to 50% by weight, and it is possible to use, for example, the products known from the prior art that have been obtained by copolymerization of styrene and 1,3-butadiene in aqueous emulsion.

For example, the halogenated copolymer of a C4 to C7 isoolefin and an alkylstyrene may consist of an isobutylene and a methylstyrene, where the styrene unit may be ortho-, meta- or para-alkylated. The copolymer may have been halogenated with any halogen. Preference is given to using a brominated copolymer of isobutylene and para-methylstyrene. The diene rubbers used in the mixture, especially styrene-butadiene copolymers, may also be used in partly or fully functionalized form. The functionalization can be effected with groups which can interact with the fillers used, especially with fillers bearing OH groups. Functionalizations may, for example, be those with hydroxyl groups and/or epoxy groups and/or siloxane groups and/or amino groups and/or phthalocyanine groups and/or carboxyl groups and/or silane sulfide groups.

Preference is given in this respect to a process of the invention wherein the crosslinkable rubberization mixture comprises 25 to 100 phr, preferably 50 to 100 phr, more preferably 70 to 100 phr, of the at least one diene rubber.

Preference is additionally given to a process of the invention wherein the crosslinkable rubberization mixture comprises 15 to 50 phr of a brominated copolymer of isobutylene and para-methylstyrene and/or 25 to 85 phr of natural and/or synthetic polyisoprene and/or 15 to 50 phr of cis-1,4-butadiene rubber.

Preference is also given to a process of the invention wherein the crosslinkable rubberization mixture comprises 10 to 90 phr, preferably 15 to 40 phr, of a filler, preferably amorphous silicon dioxide, especially precipitated silica, where the crosslinkable rubberization mixture most preferably comprises a polar filler, especially amorphous silicon dioxide, and one or more silane compounds for binding of the polar fillers. The filler may be any suitable material known in the prior art for use as a filler, or a mixture of these materials. The rubberization mixture preferably comprises silica as filler, which is referred to in the specialist field as amorphous silicon dioxide. This may comprise customary silicas for tire rubber mixtures. It is particularly preferable when a finely divided, precipitated silica is used, having a CTAB surface area (to ASTM D 3765) of 30 to 350 m²/g, preferably of 120 to 250 m²/g. Silicas used may, for example, be either conventional silicas, such as those of the VN3 type (trade name) from Evonik, or highly dispersible silicas known as HD silicas (e.g. Ultrasil 7000 from Evonik).

For some applications, preference is given to a process of the invention wherein the crosslinkable rubberization mixture additionally comprises 0.1 to 10 phr of further fillers, where the further fillers are selected from the group consisting of aluminosilicates, chalk, starch, magnesium oxide, titanium dioxide, rubber gels and combinations of these fillers. Preference is alternatively given to a process of the invention wherein the crosslinkable rubberization mixture comprises less than 0.005 phr, preferably less than 0.001 phr, of the further fillers.

In order to obtain filler-containing transmissive rubberizations, it is regularly productive to minimize the content of black pigments and other colorants. Preference is therefore given to a process of the invention wherein the crosslinkable rubberization mixture comprises less than 1 phr, preferably less than 0.1 phr, more preferably less than 0.01 phr, of black colorants, especially black pigments, especially carbon black, graphene or carbon nanotubes, as filler.

The vulcanization of the crosslinkable rubberization mixture is regularly performed in the presence of sulfur and/or sulfur donors, and some sulfur donors can simultaneously act as vulcanization accelerators. Sulfur or sulfur donors are added to the rubberization mixture in the last mixing step in the amounts that are commonly used by the person skilled in the art (0.4 to 8 phr, sulfur preferably in amounts of 0.4 to 4 phr). The vulcanization can also be effected in the presence of very small amounts of sulfur in combination with sulfur donor substances. In addition, the rubberization mixture may comprise vulcanization-influencing substances such as vulcanization accelerators, vulcanization retardants and vulcanization activators in customary amounts, in order to control the time required and/or the temperature required in the vulcanization and to improve the vulcanizate properties. The vulcanization accelerators may, for example, be selected from the following groups of accelerators: thiazole accelerators, for example 2-mercaptobenzothiazole, sulfenamide accelerators, for example benzothiazyl-2-cyclohexylsulfenamide (CBS), guanidine accelerators, for example N,N′-diphenylguanidine (DPG), dithiocarbamate accelerators, for example zinc dibenzyldithiocarbamate, disulfides, thiophosphates. The accelerators can also be used in combination with one another, which can give rise to synergistic effects. Against this background, preference is given to a process of the invention wherein the crosslinkable rubberization mixture comprises 0.4 to 8.0 phr, preferably 0.4 to 4 phr, more preferably 0.5 to 2.5 phr, of sulfur, where the crosslinkable rubberization mixture preferably comprises one or more further vulcanization additives selected from the group consisting of vulcanization accelerators, vulcanization retardants and vulcanization activators.

Preference is additionally given to a process of the invention wherein the crosslinkable rubberization mixture comprises one or more additives selected from the group consisting of coupling agents, especially silane coupling agents, plasticizers, aging stabilizers, activators, waxes, tackifying resins, mastication aids and processing aids. Useful plasticizers include all plasticizers known to those skilled in the art, for example aromatic, naphthenic or paraffinic mineral oil plasticizers, for example MES (mild extraction solvate) or TDAE (treated distillate aromatic extract), or rubber-to-liquid oils (RTL) or gas-to-liquid oils (GTL) or biomass-to-liquid oils (BTL; as disclosed, for example, in DE 10 2008 037 714 A1) or oils based on renewable raw materials, for example rapeseed oil, terpene oils (e.g. orange oils) or factices or plasticizer resins or liquid polymers (such as liquid BR), the average molecular weight of which (determined by GPC=gel permeation chromatography, using a method based on BS ISO 11344:2004) is in the range from 500 to 20 000 g/mol. If liquid polymers are used as plasticizers in the rubberization mixture, these are not counted as rubber in the calculation of the composition of the polymer matrix (phr calculation). When mineral oil is used, particular preference is given to white oils. Aging stabilizers are, for example, substances such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD) and 2,2,4-trimethyl-1,2-dihydroquinoline (TMQ). Activators used are, for example, zinc oxide, zinc carbonate and fatty acids (e.g. stearic acid). One example of a mastication aid is, for example, 2,2′-dibenzamidodiphenyl disulfide (DBD). The processing aids include, for instance, fatty acid salts, for example zinc soaps, and fatty acid esters and derivatives thereof, for example PEG carboxylates.

Particularly pleasing visual effects can be created when the crosslinkable rubberization mixture is colored and transmissive, especially colored and transparent, i.e. shows nonuniform absorption characteristics in the visible spectrum, which can be achieved by dyes. Preference is therefore given to a process of the invention wherein the crosslinkable rubberization mixture comprises one or more dyes.

Suitable aqueous dispersions for activation of adhesion are especially those systems that are disclosed, for example, in WO 2019/015792 A1 and in EP 3702521 A1, EP 3702522 A1 and EP 3702523 A1.

Preference is fundamentally given in this respect to a process of the invention wherein the aqueous dispersion comprises:
(w1) at least one rubber latex, provided that said rubber latex is not a polyisoprene rubber latex (including synthetic and natural polyisoprene rubber latex), and
(w2) at least one protected isocyanate, and
(w3) at least one filler and/or at least one polymer having carboxylic acid-functional groups and/or at least one polyisoprene rubber (including synthetic and natural polyisoprene rubber latex) and/or at least one wax.

An example of useful rubber latex is VP latex. VP latex is known to those skilled in the art. “VP” stands for “vinylpyridine”, and known VP latices may also include additional monomers. A preferred example of a VP latex is a vinylpyridine latex which typically comprises 15% vinylpyridine, 15% styrene and 70% butadiene monomers. As well as the VP latex, the aqueous dispersion may comprise one or more additional latices, for instance a styrene-butadiene latex (SVR) and natural latex (NR).

For isoprene rubber, preference is given to the use of natural latex with a high ammonia content that comes from the “Hevea Brasiliensis” tree.

Suitable polyisocyanate compounds as a constituent of bath/dips for textile strength members are known in principle to those skilled in the art. The polyisocyanate compound may be blocked with another compound or be in the form of a dimer or higher homolog, i.e. in “self-blocked” form. Blocked polyisocyanates are, for example and with preference, obtained by blocking free isocyanates with at least one substance selected from the group consisting of phenol, thiophenol, chlorophenol, cresol, resorcinol, p-sec-butylphenol, p-tert-butylphenol, p-sec-amylphenol, p-octylphenol, p-nonylphenol, tert-butyl alcohol, diphenylamine, dimethylaniline, phthalimide, δ-valerolactam, ε-caprolactam, dialkyl malonate, acetylacetone, alkyl acetoacetate, acetoxime, methyl ethyl ketoxime, 3,5-dimethylpyrazole, cyclohexanone oxime, 3-hydroxypyridine and acidic sodium sulfite. It is preferable in the context of the present invention for the polyisocyanate compound to comprise units selected from the group consisting of tetramethylene diisocyanate, hexamethylene diisocyanate, diphenylmethane 4,4′-diisocyanate, octamethylene diisocyanate, decamethylene diisocyanate, dodecamethylene diisocyanate, aromatic diisocyanates comprising toluene 2,4- or 2,6-diisocyanate, tetramethylxylylene diisocyanate, p-xylene diisocyanate, 2,4′- or 4,4′-diisocyanatodiphenylmethane, phenyl 1,3- or 1,4-diisocyanate.

The polycarboxylic acid is based, for example, to an extent of 10 to 100 mol %, preferably to an extent of 30 to 100 mol %, more preferably to an extent of 50 to 100 mol %, even more preferably to an extent of 70 to 100 mol %, especially preferably to an extent of 90 to 100 mol %, on monomers containing carboxylic acid groups. In a particularly advantageous embodiment of the invention, the polycarboxylic acid is based to an extent of 100 mol % on monomers containing carboxylic acid groups, without ruling out further functional groups. Preferably, the polycarboxylic acid has a weight-average molecular weight Mw by GPC of 1000 to 500 000 g/mol, preferably 3000 to 100 000 g/mol. Preferably, the polycarboxylic acid is based on acrylic acid, methacrylic acid, itaconic acid, crotonic acid, cinnamic acid and/or maleic acid monomers. In a preferred embodiment, the polycarboxylic acid (based on acrylic acid monomers) is an acrylic resin.

Suitable epoxy compounds as a constituent of corresponding aqueous dispersions are known in principle to the person skilled in the art. It is preferable in the context of the present invention for the epoxy compound to be selected from the group consisting of glycidyl-based glycerol, sorbitol-based epoxy compounds, phenol-based novolak epoxy compounds and cresol-based novolak epoxy compounds. A particularly suitable example of an epoxy compound is a glycerol-based polyglycidyl ether, for example Denacol™ EX-313, which is described inter alia in DE 69722388 T2.

Possible waxes as a constituent of corresponding aqueous dispersions are known in principle to the person skilled in the art. Preferred examples are paraffinic waxes, microcrystalline waxes, synthetic waxes and waxes from natural sources, for example beeswax, also including combinations of two or more waxes.

Particularly suitable fillers for the aqueous dispersion are water-dispersible inorganic fillers. Particular preference is given to amorphous silicon dioxide (especially precipitated silica) and silicates having a BET surface area (to ISO 9277:2010) of 30 to 450 m²/g, preferably of 120 to 410 m²/g.

The aqueous dispersion preferably has a pH of 5 to 11, preferably of 7 to 11, which can appropriately be established with a base. The base is preferably a volatile base which evaporates, or the constituents of which evaporate, during the process. In a particularly advantageous embodiment of the invention, the base is ammonium hydroxide, i.e. an aqueous solution of ammonia.

In the light of the above details, preference is given to a process of the invention wherein the aqueous dispersion comprises:
(x1) at least one rubber latex, preferably in a proportion by mass based on the dry weight of the aqueous dispersion of 4% to 60%, and
(x2) at least one protected isocyanate, preferably in a proportion by mass based on the dry weight of the aqueous dispersion of 0.1% to 10%.

Preference is additionally given to a process of the invention wherein the aqueous dispersion comprises:
(y1) at least one compound containing an epoxy group, preferably in a proportion by mass based on the dry weight of the aqueous dispersion of up to 6%, and/or
(y2) at least one polymer having carboxylic acid-functional groups, preferably in a proportion by mass based on the dry weight of the aqueous dispersion of up to 15%.

Particular preference is given to a process of the invention wherein the aqueous dispersion comprises one of the following components:
(z1) at least one filler, preferably in a proportion by mass based on the dry weight of the aqueous dispersion of 0.02% to 20%, preferably with the proviso that the aqueous dispersion does not include any polymer having carboxylic acid-functional groups,
or
(z2) at least one polyisoprene rubber latex, preferably in a proportion by mass based on the dry weight of the aqueous dispersion of 1% to 20%, preferably with the proviso that the aqueous dispersion includes at least one rubber latex which is not a polyisoprene rubber latex,
or
(z3) at least one wax, preferably in a proportion by mass based on the dry weight of the aqueous dispersion of 0.3% to 30%.

Among the possible aqueous dispersions for activation of adhesion, in the opinion of the inventors, three specific embodiments are particularly suitable.

To wit, preference is given to a process of the invention wherein the aqueous dispersion comprises:
(h1) at least one rubber latex, in a proportion by mass based on the dry weight of the aqueous dispersion of 4% to 50%, preferably of 4.5% to 25%,
(h2) at least one protected isocyanate, in a proportion by mass based on the dry weight of the aqueous dispersion of 0.1% to 4.5%, preferably of 0.2% to 4%,
(h3) at least one filler, in a proportion by mass based on the dry weight of the aqueous dispersion of 0.02% to 20%, preferably of 0.3% to 15%.

Preference is alternatively given to a process of the invention wherein the aqueous dispersion comprises:
(i1) at least one rubber latex, in a proportion by mass based on the dry weight of the aqueous dispersion of 4% to 50%, preferably of 4.5% to 25%,
(i2) at least one protected isocyanate, in a proportion by mass based on the dry weight of the aqueous dispersion of 0.1% to 10%, preferably 0.2% to 4.5%,
(i3) at least one wax, in a proportion by mass based on the dry weight of the aqueous dispersion of 0.3% to 30%, preferably of 0.5% to 15%.

Preference is alternatively in turn given to a process of the invention wherein the aqueous dispersion comprises:
(j1) at least one rubber latex, in a proportion by mass based on the dry weight of the aqueous dispersion of 4% to 40%, preferably of 4.5% to 20%, where the rubber latex is not a polyisoprene rubber latex,
(j2) at least one protected isocyanate, in a proportion by mass based on the dry weight of the aqueous dispersion of 0.1% to 10%, preferably 0.2% to 4.5%,
(j3) at least one polyisoprene rubber latex, preferably in a proportion by mass based on the dry weight of the aqueous dispersion of 1% to 20%, preferably 2% to 15%.

With exploitation of the advantageous lack of intrinsic color of the aqueous dispersion, the resultant activation of adhesion can be particularly easily colored. Preference is therefore given to a process of the invention wherein the aqueous dispersion comprises one or more pigments and/or dyes.

Even though a different application method is possible, the aqueous dispersion is preferably applied as a dip. Preference is therefore given to a process of the invention wherein the treatment in step b) comprises dipping the textile strength member into the aqueous dispersion, wherein the treatment preferably additionally comprises hot stretching of the dipped textile strength members.

The vulcanizable composite materials produced by the process of the invention may be incorporated into blanks, for example into blanks for bicycle tires. Preference is consequently also given to a process of the invention additionally comprising the step of:
d) producing an unvulcanized blank, especially an unvulcanized vehicle tire blank, comprising the vulcanizable composite material.

The unvulcanized blanks manufactured above, or else in less preferred cases merely the unvulcanized composite materials, can be used to produce, by vulcanization, the advantageous vulcanized composite materials or the elastomeric products comprising said vulcanized composite materials. The invention therefore also relates to a process for producing an elastomeric product, especially a vehicle tire, or a vulcanized composite material, comprising the steps of the process of the invention for producing a vulcanizable composite material, and additionally at least one of the following steps:
e) vulcanizing the vulcanizable composite material to obtain a vulcanized composite material, and/or
f) vulcanizing the unvulcanized blank to obtain an elastomeric product.

Preference is given in this respect to a process of the invention wherein the elastomeric product is a bicycle tire, wherein the width of the tire casing transverse to rolling direction is preferably in the range from 20 to 70 mm, preferably in the range from 25 to 65 mm, and/or wherein the internal diameter of the tire casing is preferably in the range from 340 to 640 mm, preferably in the range from 550 to 630 mm.

Very particular preference is given to a process of the invention wherein the elastomeric product is a vehicle tire comprising the vulcanized composite material as part of the carcass, preferably in the region of the sidewall, wherein the vulcanized composite material is preferably additionally covered at least in sections by a vulcanized rubber mixture which is at least partly transmissive to visible light.

In the light of the above details, it will be apparent to the person skilled in the art that the invention also relates to the vulcanizable composite material produced by the process of the invention, to the vulcanized composite material producible therefrom and to the corresponding elastomeric products, respectively resulting in the benefits discussed above.

The invention thus also relates to a vulcanizable composite material for the production of elastomeric products, especially of vehicle tires, preferably produced or producible by the process of the invention for production of a vulcanizable composite material, comprising:
i) at least one textile strength member that has been adhesion-activated at least in sections, preferably essentially entirely, with an aqueous dispersion, and
ii) a crosslinkable rubberization mixture that surrounds the textile strength member,
wherein the aqueous dispersion is essentially free of free resorcinol and resorcinol precondensates, especially resorcinol-formaldehyde precondensates, and is free of free formaldehyde and formaldehyde-releasing substances,
wherein the crosslinkable rubberization mixture is processible by vulcanization to give a crosslinked rubberization mixture which is at least partly transmissive to visible light at least in sections.

Since the activation of adhesion caused by the aqueous dispersion is a complex coating having a structure that inherently cannot be described precisely, it is necessary to define the textile strength members used in the vulcanizable composite material of the invention via the activation of adhesion that they undergo.

In this respect, preference is given to a vulcanizable composite material of the invention wherein the textile strength member is adhesion-activated with the aqueous dispersion on all sections surrounded by the crosslinkable rubberization mixture.

The invention consequently likewise relates to a vulcanized composite material produced or producible by vulcanization of the vulcanizable composite material of the invention, preferably by the process of the invention for production of a vulcanized composite material comprising a crosslinked rubberization mixture which is at least partly transmissive to visible light.

The invention likewise relates to an elastomeric product, especially vehicle tire, comprising a vulcanized composite material of the invention, preferably produced or producible by the process of the invention for production of an elastomeric product.

Preference is given in this respect to an elastomeric product wherein the elastomeric product is a vehicle tire comprising the vulcanized composite material as part of the carcass, preferably in the region of the sidewall, wherein the vulcanized composite material is additionally covered at least in sections by a vulcanized rubber mixture which is at least partly transmissive to visible light.

Preference is additionally given to an elastomeric product additionally comprising, in the region of the vulcanized composite material, one or more rubber labels applied by vulcanization and/or a printed label, preferably one or more rubber labels applied by vulcanization.

The invention finally also relates to the use of an aqueous dispersion for adhesive activation of textile strength members for composite materials with transparent rubberization mixtures for improvement of visual identifiability of the textile strength members in the transparent rubberization mixture and/or for reduction of optical defects in the contact region between the textile strength members and the transparent rubberization mixture, wherein the aqueous dispersion is essentially free of free resorcinol and resorcinol precondensates, especially resorcinol-formaldehyde precondensates, and is free of free formaldehyde and formaldehyde-releasing substances.

Proposed hereinafter is an illustrative configuration of the process of the invention, which, in the view of the inventors, is a particularly advantageous configuration. Moreover, an inventive bicycle tire produced by this illustrative process is proposed, which, in the view of the inventors, is likewise a particularly favorable embodiment of a product of the invention in which the benefits of the present invention are manifested particularly clearly.

In the context of the illustrative process, a textile strength member is provided, which is a weave composed of multiple reinforcement cords, where the reinforcement cords are respectively an aramid yarn having a linear density of 420 dtex and a nylon yarn having a linear density of 470 dtex, which are end-twisted together at 320 T/m. The aramid yarn used is yellowish in color, whereas the nylon yarn has a manufacturer-specific identification thread marker.

The textile strength member is adhesion-activated with an aqueous dispersion by a dipping method and process by hot stretching. The aqueous dispersion does not contain free resorcinol or resorcinol condensates or free formaldehyde or formaldehyde-releasing substances. The aqueous dispersion used is a composition comprising vinylpyridine latex in a proportion by mass based on dry weight of 20%, blocked hexamethylene diisocyanate in a proportion by mass based on dry weight of 5%, and polyisoprene rubber latex in a proportion by mass based on dry weight of 10%. In addition, the aqueous dispersion preferably also comprises an acrylic acid-based polycarboxylic acid and, as epoxy compound, glycerol-based polyglycidyl ether.

Subsequently, the adhesion-activated textile strength member is fully embedded into a crosslinkable rubberization mixture. The crosslinkable rubberization mixture comprises 25 phr of a brominated copolymer of isobutylene and para-methylstyrene and 55 phr of natural polyisoprene and 20 phr of cis-1,4-butadiene rubber. The crosslinkable rubberization mixture additionally comprises 30 phr of amorphous silicon dioxide as filler and is free of black colorants, especially black pigments such as carbon black or graphene. As part of a customary vulcanization system, the crosslinkable rubberization mixture additionally comprises 2.4 phr of sulfur, and additionally customary further constituents such as silane coupling agents and tackifying resins, where these are selected such that they do not impair the transparency of the crosslinked rubberization mixture. This crosslinkable rubberization mixture results, after the vulcanization, in a crosslinked rubberization mixture which, in its entirety, is transmissive to visible light having wavelengths in the range from 380 to 780 nm, such that the strength members embedded in the transparent crosslinked rubberization mixture are readily apparent from the outside to the naked eye.

The vulcanizable composite material produced as described above, as part of the tire carcass, is assembled together with other components to give an unvulcanized bicycle tire blank, where the vulcanizable composite material in the side region of the bicycle tire blank is exposed and not covered with an additional sidewall. In this case, the vulcanizable composite material may form part of the tire carcass or alternatively be applied to a tire carcass.

Subsequently, vulcanization of the unvulcanized bicycle tire blank under customary conditions affords a bicycle tire that comprises, in the region of the sidewall, the vulcanized composite material that forms the outermost layer of the bicycle tire, such that the textile strength members are visible, in that these advantageously remain visible in the original color and hence clearly stand out against the dark lower layers of the carcass.

1. A method for UE-to-UE relaying resource management between communication subscribers, which can each communicate with at least one base station via at least one communication interface for communication, in which the following steps are carried out on the part of the base station for establishing communication:
determining local and thematic information for determining communication subscribers;
determining a group of communication subscribers based on the local and thematic information, wherein a local area is defined for local restriction of the communication subscribers and wherein at least one of a technological aspect and an interest-related aspect is used for thematic restriction on the part of the base station;
characterized in that,
granting permission to communicate data from a group of communication subscribers to the at least one base station is established via further communication subscribers by using discovery mechanisms between them the interest-related aspect are radio resources, which can be organized in an orthogonal manner according to the requested or offered further communication subscribers.

2. The method according to claim 1, wherein
a) at least one base station computes and provides to further communication subscribers the node in the resources assigned for relaying;
b) broadcast this to further communication subscribers;
c) relaying request indicating QoS parameters;
d) acceptance by further communication subscribers or at least one base station.

3. The method according to claim 1,
characterized in that,
that a possible relay node request of further communication subscribers is done on-demand.

4. The method according to claim 1,
characterized in that,
a discovery mechanism used by further communication subscribers is established by announcing its presence and capabilities by regularly transmitting discovery information in a broadcast manner.

5. The method according to claim 1,
characterized in that,
a discovery mechanism used by communication subscribers is established by announcing their presence and inquire for communication partners by issuing corresponding discovery messages regularly.

6. The method according to claim 1,
characterized in that,
once the group has been determined by at least one further communication subscriber based on network configuration and prioritization by the base station of the data transmitted for the group of communication subscribers to the base station.

7. The method according to claim 1,
characterized in that,
data transmitted for the group of communication subscribers as requested from and provided by the base station a technological aspect includes at least any type of resources that are used by the communication subscribers.

8. The method according to claim 1,
characterized in that,
technological aspect includes at least any type of resources including the use of bandwidth parts, whereby bandwidth parts consists of contiguous sub-set of resources within a component carrier.

9. The method according to claim 1,
characterized in that,
technological aspect includes at least any type of resources including the use of carrier aggregation.

10. The method according to claim 1,
characterized in that,
technological aspect includes at least any type of resources including dual connectivity.

11. The method according to claim 1,
characterized in that,
technological aspect includes the aspect of relay selection single-hop or multi-hop PC5-to-Uu relaying by introducing a composite load metric.

12. The method according to claim 1,
characterized in that,
the relay selection meets the communication subscribers E2E QOS requirements, and triggering a procedure for selection and/or reselection for further communication subscribers.

13. The method according to claim 1,
characterized in that,
the communication subscribers.

14. The method according to claim 1,
characterized in that,
the local and thematic information is determined from the mean value of the spatial coordinates of the end users and the respective relative speed v and average direction of the end users.

15. A communication unit for communication in a vehicle of a user to at least one base station comprising a microprocessor, volatile and non-volatile memory and at least one communication interface, which are communicatively connected to the at least one base station or further communication subscribers via one or more mobile communication lines, wherein the communication unit is adapted to perform operations for UE-to-UE relaying resource management between communication subscribers, which can each communicate with at least one base station via at least one communication interface for communication, in which the following steps are carried out on the part of the base station for establishing communication, the operations comprising:
determining local and thematic information for determining communication subscribers;
determining a group of communication subscribers based on the local and thematic information, wherein a local area is defined for local restriction of the communication subscribers and wherein at least one of a technological aspect and an interest-related aspect is used for thematic restriction on the part of the base station;
characterized in that,
granting permission to communicate data from a group of communication subscribers to the at least one base station is established via further communication subscribers by using discovery mechanisms between them the interest-related aspect are radio resources, which can be organized in an orthogonal manner according to the requested or offered further communication subscribers.

16. (canceled)

17. (canceled)

18. (canceled)

19. The communication unit according to claim 15, wherein
a) at least one base station computes and provides to further communication subscribers the node in the resources assigned for relaying;
b) broadcast this to further communication subscribers;
c) relaying request indicating QoS parameters;
d) acceptance by further communication subscribers or at least one base station.

20. communication unit according to claim 15,
characterized in that,
that a possible relay node request of further communication subscribers is done on-demand.

21. The communication unit according to claim 15,
characterized in that,
a discovery mechanism used by further communication subscribers is established by announcing its presence and capabilities by regularly transmitting discovery information in a broadcast manner.

22. The communication unit according to claim 15,
characterized in that,
a discovery mechanism used by communication subscribers is established by announcing their presence and inquire for communication partners by issuing corresponding discovery messages regularly.

23. The communication unit according to claim 15,
characterized in that,
once the group has been determined by at least one further communication subscriber based on network configuration and prioritization by the base station of the data transmitted for the group of communication subscribers to the base station.
